(19) United States
(12) Patent Application Publication
(10) Pub. No.: US 2017/0101424 A1
(43) Pub. Date: Apr. 13, 2017

(54) PROCESS FOR HYDROSILYLATION WITH ADDITION OF ORGANIC SALTS

(71) Applicant: Wacker Chemie AG, Munich (DE)

(72) Inventors: Agnes BASKAKOV, Hochburg (AT); Christine KAES, Burghausen (DE)

(21) Appl. No.: 15/121,994

(22) PCT Filed: Feb. 20, 2015
(86) PCT No.: PCT/EP2015/053621

§ 371 Date: Aug. 26, 2016

(30) Foreign Application Priority Data
Feb. 28, 2014 (DE) 10 2014 203 770.0

(51) Int. Cl. C07F 7/14

(52) U.S. Cl. CPC C07F 7/14

(57) ABSTRACT

Hydrosilylation of aliphatically unsaturated compounds (B) with compounds (A) bearing silicon-bonded hydrogen using a metal-containing hydrosilylation catalyst proceeds with higher yields and reduced quantities of byproducts when conducted in the presence of organic salts containing an inorganic or organic anion [Y]− and a heteroatom-containing cation [A]+ in amounts of 0.01 mole % to 10 mole % based on the limiting amount of (A) or (B) in moles present in the reaction.

### CROSS REFERENCE TO RELATED APPLICATIONS

This application is the U.S. National Phase of PCT Appln. No. PCT/EP2015/053621 filed Feb. 20, 2015, which claims priority to German Application No. 10 2014 203 770.0 filed Feb. 28, 2014, the disclosures of which are incorporated in their entirety by reference herein.

### BACKGROUND OF THE INVENTION

1. Field of the Invention

The invention relates to a process for preparing organosilicon compounds by hydrosilylation with the aid of a transition metal catalyst and with addition of organic salts which comprise one or more heteroatoms.

2. Description of the Related Art

In the prior art, organosilicon compounds are prepared by the Müller-Rochow synthesis. The functionalized organosilanes are of great economic significance, particularly the halogen-substituted species, since they serve as starting products for the production of numerous important products, examples being silicones, adhesion promoters, water repellents, and architectural preservatives. However, this direct synthesis is not equally suited to all silanes. Preparation of less common, so-called “deficiency” silanes by this route is difficult, and is possible only with poor yields and selectivities.

One way of preparing deficiency silanes is to convert easily preparable silanes (over abundant silanes) into deficiency silanes by means of a substituent exchange reaction. A process of this kind for substituent exchange of organochlorosilanes with other organochlorosilanes is described in DE 101 57 198 A1, for example. Here, a substituent exchange reaction takes place on the silicon atom, and an organosilane is disproportionated in the presence of an ionic liquid or reacted with another organosilane in a substituent exchange reaction.

The hydrosilylation of 1-alkenes is known to be catalyzed via metal complexes of the platinum group. In particular, platinum complexes such as, for example, those known as Speier catalyst [H₂PtCl₆*6 H₂O] and Karstedt solution, a complex compound of [H₂PtCl₆*6 H₂O] and vinyl-substituted disiloxanes, are known to be highly active catalysts.

In certain cases, the transition-metal-catalyzed hydrosilylation reaction is notable for insufficient selectivity and low yield. Processes described in the literature attempt to circumvent these limitations by using alternative solvents, such as, for example, ionic liquids—DE 10 2006 029 430 A, CN 101033235 A, PL 212882 B1; use of linear carbonyl compounds and/or esters—EP 0 856 517 A1; or silyl esters, amide compounds having N—Si bonds, urea compounds, phosphoric acid compounds, or hydroxypyridine compounds, as described in DE 601 05 986 T2, among others.

### SUMMARY OF THE INVENTION

It was an object of the present invention to provide a process for preparing silanes by hydrosilylation that is distinguished by very high selectivity and yield in respect of the desired silanes and also by ease of technical realization. These and other objects are provided by a process for addition of Si-bonded hydrogen onto an aliphatic carbon-carbon multiple bond by reaction of

(A) organosilicon compounds having Si-bonded hydrogen atoms with
(B) compounds which have aliphatic carbon-carbon multiple bonds, in the presence of
(C) a metal catalyst which promotes the addition of Si-bonded hydrogen onto aliphatic multiple bonds, in an amount of 1 to 500 mol-ppm, preferably 1 to 200 mol-ppm, more preferably 1 to 70 mol-ppm, in each case based on the limiting component (A) or (B) used, and of
(D) at least one organic salt of the general formula

[A]⁺[Y]⁻ (5),

where
[Y]⁻ is an inorganic or organic anion and
[A]⁺ is an organic cation which contains at least one heteroatom selected from the group consisting of nitrogen, phosphorus, oxygen, and sulfur, in an amount of 0.01 to 10 mol %, preferably 0.1 to 5 mol %, more preferably 0.1 to 2 mol %, in each case based on the limiting component (A) or (B),
with the proviso that the molar ratio of metal atom in component (C) to salt (D) is 1:1 to 1:500, preferably 1:1 to 1:200, more preferably 1:1 to 1:25.

### DETAILED DESCRIPTION OF THE PREFERRED EMBODIMENTS

In the context of the present invention, the designation “organic salt” is also intended to comprehend salts which include silicon atoms.

The compounds used as component (A) in the process of the invention may be any desired organosilicon compounds known to date which have at least one Si-bonded hydrogen atom, such as SiH-functional silanes (A1) and siloxanes (A2), for example.

Component (A) preferably comprises hydrogensilanes (A1) of the general formula

H_{4-a-b}SiRₐX_{b} (1),

where
R may be identical or different and is optionally substituted hydrocarbon radicals free from aliphatic carbon-carbon multiple bond,
X may be identical or different and is chlorine atom, bromine atom, methoxy or ethoxy radical,
a is 0, 1, 2 or 3, and
b is 0, 1, 2 or 3, with the proviso that the sum a+b is 1, 2 or 3, preferably 2 or 3, more preferably 3.

Radical X is preferably chlorine.

Radicals R are preferably linear, branched, or cyclic alkyl groups or aryl groups, more preferably linear, branched, or cyclic alkyl groups having 1 to 18 carbon atoms, most preferably methyl radicals.

The hydrogensilanes of the formula (1) are preferably HSiCl₃, HSiCl₂Me, HSiClMe₂, HSiCl₂Et, and HSiClEt₂, HSi(OMe)₃, HSi(OEt)₃, HSi(OMe)₂Me, HSi(OEt)₂Me, HSi(OMe)Me₂, and HSi(OEt)Me₂, more preferably HSiCl₃, HSiMeCl₂, and HSiMe₂Cl, where Me is the methyl radical and Et is the ethyl radical.

Furthermore, in the process of the invention, polymeric organosilicon compounds (A2) may be used as constituent (A).

Examples of compounds which may be used as component (A2) in the process of the invention are all polymeric organosilicon compounds which have Si-bonded hydrogen atoms and which have also been used to date in hydrosilylation reactions.

The organosilicon compounds (A2) are preferably linear, cyclic, or branched siloxanes composed of units of the formula

R¹_{c}H_{d}SiO_{(4-c-d)/2} (2),

where
R¹ may be identical or different and has a definition stated above for R,
c is 0, 1, 2, or 3, and
d is 0, 1 or 2, preferably 0 or 1,
with the proviso that the sum of c+d is less than or equal to 3 and in at least one unit d is other than 0.

Examples of compounds which can be used as component (B) in the process of the invention are all aliphatically unsaturated compounds which have also been used to date in hydrosilylation reactions.

The compound (B) used in accordance with the invention may comprise silicon-free organic compounds having aliphatically unsaturated groups (B1), and also organosilicon compounds having aliphatically unsaturated groups (B2), preferably silicon-free organic compounds (B1).

Components (B1) are preferably compounds having aliphatic double or triple bonds, more preferably compounds of the general formula

R⁸R⁹C═CR¹⁰R¹¹ (3),

where
R⁸, R⁹, R¹⁰, and R¹¹ independently of one another are hydrogen atom, monovalent hydrocarbon radicals having 1 to 18 carbon atoms and optionally substituted by —F, —Cl, —OR⁶, —NR⁷₂, —CN, or —NCO, or are chlorine, fluorine, or alkoxy radicals having 1 to 18 carbon atoms; pairs of the radicals R⁸, R⁹, R¹⁰, and R¹¹ with the definition of optionally substituted hydrocarbon radicals may form a cyclic radical together with the carbon atoms to which they are bonded.

Where compounds of the formula (3) are noncyclic compounds, radicals R⁸ and R⁹ preferably are hydrogen.

Where compounds of the formula (3) are noncyclic compounds, radicals R¹⁰ and R¹¹ independently of one another, preferably are hydrogen or hydrocarbon radicals having 1 to 18 hyrdocarbon atoms optionally substituted by chlorine, chlorine, more preferably hydrogen atom or the chloromethyl radical.

Where compounds of the formula (3) are cyclic compounds, cyclopentenes and cyclohexenes are preferred.

Radical R⁶ preferably comprises radicals having 1 to 18 carbon atoms, more preferably hydrocarbon radicals having 1 to 18 carbon atoms.

Radical R⁷ preferably comprises radicals having 1 to 18 carbon atoms, more preferably hydrocarbon radicals having 1 to 18 carbon atoms.

The compounds (B1) used in accordance with the invention are preferably 3-chloroprop-1-ene, which is also referred to as allyl chloride, or 3-chloro-2-methylprop-1-ene, also called methallyl chloride, propene, acetylene, ethylene, isobutylene, cyclopentene, cyclohexene, 1-octene, 1-dodecene, and 1-hexadecene, particular preference being given to 3-chloroprop-1-ene, cyclopentene, and cyclohexene.

In one preferred embodiment of the process of the invention, it is also possible as component (B1), with particular preference, to use 1-dodecene, in particular in small amounts for the accommodation of component (C).

Furthermore, in the process of the invention, aliphatically unsaturated organosilicon compounds (B2) may be used as constituent (B), but this is not preferred.

The organosilicon compounds (B2) are preferably silanes or linear, cyclic, or branched siloxanes composed of units of the formula

R²ₑR³_{f}SiO_{(4-e-f)/2} (4),

where
R² may be identical or different and are SiC-bonded, aliphatically unsaturated hydrocarbon radicals,
R³ may be identical or different and are optionally substituted, SiC-bonded aliphatically saturated hydrocarbon radicals,
e is 0, 1, 2, 3, or 4, preferably 0, 1, or 2, and
f is 0, 1, 2, or 3, with the proviso that the sum e+f is less than or equal to 4 and compound (B2) has at least one radical R².

The organosilicon compounds (B2) used in accordance with the invention may be silanes, i.e., compounds of the formula (4) with e+f=4, and siloxanes, i.e. compounds composed of units of the formula (4) with e+f≦3.

Examples of organosilicon compounds (B2) are trimethylvinylsilane, 1,2-divinyltetramethyldisiloxane, and vinyl-terminated organopolysiloxanes.

The components (A) and (B) used in accordance with the invention are commercial products and/or are preparable by methods common within chemistry.

In one preferred embodiment of the process of the invention, HSiCl₃, HSiMeCl₂, or HSiMe₂Cl is used as compound (A), and allyl chloride is used as component (B); here, Me is methyl radical.

In the process of the invention, constituent (B) is preferably used in an amount such that the molar ratio of aliphatically unsaturated groups in constituent (B) to SiH groups in constituent (A) is 20:1 to 1:20, more preferably 10:1 to 1:10, and most preferably 2:1 to 1:2.

In one embodiment of the process of the invention, component (A) may represent the “limiting” component; in other words, in the mixture comprising components (A) and (B), there are more aliphatically unsaturated groups of constituent (B) than SiH groups of constituent (A).

In another embodiment of the process of the invention, component (B) may represent the “limiting” component; in other words, in the mixture comprising components (A) and (B), there are fewer aliphatically unsaturated groups of constituent (B) than SiH groups of constituent (A).

In the process of the invention, components (A) and (B) are preferably used in amounts such that component (B) represents the deficit component.

The reaction of compounds (A) which carry one or more H—Si functionalities, in accordance with the invention, takes place in one preferred embodiment with alkenes (B) which as well as carbon and hydrogen may additionally include chlorine, alkoxy, or amino functionalities. In that case, a further problem arises, additionally, that—as is known—the hydrosilylation reaction may be accompanied by the transfer of the chlorine, alkoxy, or amino functionalities to the hydrosilylation catalyst or to the compounds (A) used, and this restricts the achievable yield in the prior-art hydrosilylation process to such an extent that there have to date been no satisfactory technical solutions in particular for the reaction of such compositions. In view of the technical importance of these chloro-, alkoxy-, or amino-functionalized hydrosilylation products, the solution provided by the invention to this problem has significant economic potential.

As constituent (C), which promotes the addition reaction (hydrosilylation) between the aliphatic carbon-carbon multiple bonds and Si-bonded hydrogen, metal-containing hydrosilylation catalysts which can be used in the materials of the invention are all of those known to date.

In the process of the invention, preference is given to using, as component (C), complex compounds of platinum, iridium, or of rhodium, more preferably complex compounds of platinum, yet more preferably platinum(IV) complexes, and most preferably the complexes PtCl₄ and H₂PtCl₆.

In the process of the invention, catalyst (C) may be used in pure form or, preferably, in a mixture with component (B1) or solvent (E).

Examples of optionally employed solvents (E), which are preferably inert toward component (A), are linear hydrocarbons, aromatic hydrocarbons, preferably xylene or toluene, ketones, preferably acetone, methyl ethyl ketone, or cyclohexanone, alcohols, preferably methanol, ethanol, n- or isopropanol, with the proviso that the aforesaid solvents have no aliphatic carbon-carbon multiple bonds; or the desired target product.

The optionally employed solvents (E) are preferably linear hydrocarbons free from aliphatic carbon-carbon multiple bonds, aromatic hydrocarbons free from aliphatic carbon-carbon multiple bonds, preferably xylene or toluene, or the desired target product.

If component (C) is to be used in the form of a mixture with component (B1) or solvent (E), the amount of metal, preferably Pt, in the mixture is preferably 0.1 to 10 wt %, more preferably 0.5 to 6 wt %, most preferably 1 to 6 wt %.

The amount of the catalyst (C) is guided by the desired reaction rate and also by economic considerations. In the process of the invention, catalysts (C) are used in amounts such as to result in a metal atom content of 1 to 500 mol-ppm (i.e. molar parts per million molar parts), preferably 1 to 200 mol-ppm, more preferably 1 to 70 mol-ppm, based in each case on the limiting component (A) or (B) used.

Anion [Y]⁻ preferably comprises anions selected from the group consisting of halides, thiocyanate ([SCN]⁻), tetrafluoroborate ([BF₄]⁻), hexafluorophosphate ([PF₆]⁻), [tetrakis(3,5-bis(trifluoromethyl)phenyl) borate] ([BARF]), trispentafluoroethyl trifluorophosphate ([P(C₂F₅)₃F₃]⁻), hexafluoroantimonate ([SbF₆]⁻), hexafluoroarsenate ([AsF₆]⁻), fluorosulfonate, [R′—COO]⁻, [R′—SO₃]⁻, [R′—O—SO₃]⁻, [R′₂—PO₄]⁻, and [(R′—SO₂)₂N]⁻, where R′ is a linear or branched aliphatic or alicyclic alkyl radical containing 1 to 12 carbon atoms, a C5-C18 aryl radical, or a C5-C18 aryl-C1-C6 alkyl radical some or all of whose hydrogen atoms may be substituted by fluorine atoms.

More preferably the anion [Y]⁻ comprises inorganic anions, more particularly halides, such as [F]⁻, [Cl]⁻, [Br]⁻, or [I]⁻, thiocyanate ([SCN]⁻), tetrafluoroborate ([BF₄]⁻), or hexafluorophosphate ([PF₆]⁻).

Cation [A]⁺ preferably comprises cations selected from the group consisting of

a) ammonium cations of the general formula

[NR⁴₄]⁺ (6),

b) phosphonium cations of the general formula

[PR⁵₄]⁺ (7),

c) heteroorganic cations of the general formula (8),

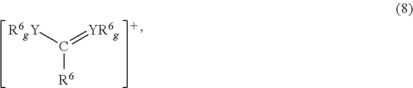

heterocyclic organic cations of the general formulae (9), (10) and (11), where in the case of formula (11) the compound may be an aromatic compound in the sense of the Hückel rule with (4n+2) Π electrons,

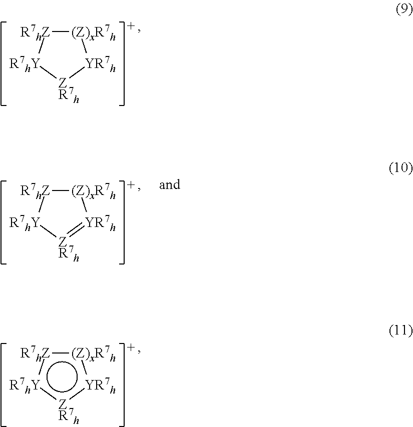

where
k independently at each occurrence is 0, 1 or 2,
Y independently at each occurrence may be identical or different and is N, O, S, C, or P,
Z independently at each occurrence may be identical or different and is C, N, O, S, P, or Si,
R⁴, R⁵, R⁶, and R⁷ in each case independently of one another may be identical or different and are hydrogen atom or an organic radical,
g independently at each occurrence may be identical or different and is 0, 1, 2, 3, or 4, depending on the valence of Y, and
h independently at each occurrence may be identical or different and is 0, 1, 2, or 3, depending on the valence of Z or Y, respectively,
with the proviso that in the formulae (8), (9), (10), and (11), the number of the radicals R⁶ and R⁷ on one of the atoms Y defined as a heteroatom, or Z defined as a heteroatom, is selected in each case such that a singly positive charge is carried by a heteroatom, and also only one at most of the two Y atoms in each formula may have the definition of carbon atom.

For the purposes of the present invention, the designation “organic radical” is also intended to encompass organosilicon radicals.

If component (D) has an organosilicon radical, preference is given to those which have neither Si-bonded hydrogen atoms nor aliphatic carbon-carbon multiple bonds.

Independently of one another, the radicals R⁴ and R⁵ are preferably hydrogen, hydrocarbon radicals having 1 to 20 carbon atoms, or silyl groups.

The radicals R⁶ and R⁷ independently of one another are preferably hydrogen, aliphatic radicals, cycloaliphatic radicals, aromatic radicals, oligoether groups, organyloxy groups, silyl groups, siloxy groups, or halides, preferably chlorides, or cyanide radicals, with the proviso that radicals R⁶ and R⁷ which are bonded to heteroatoms selected from N, P, O, and S preferably do not have the definition of halide or cyanide.

The radicals R⁶ and R⁷ independently of one another are more preferably hydrogen, hydrocarbon radicals having 1 to 22 carbon atoms, silyl groups or organyloxy groups having 1 to 22 carbon atoms, and most preferably hydrogen, aliphatic hydrocarbon radicals having 1 to 22 carbon atoms, or alkoxy groups having 1 to 22 carbon atoms.

If the radicals R⁴, R⁵, R⁶, and R⁷ are aliphatic groups, they are preferably—independently of one another—straight-chain or branched hydrocarbon radicals having 1 to 20 carbon atoms, with the chain possibly containing heteroatoms, such as oxygen, nitrogen, or sulfur atoms, for example.

Radicals R⁴, R⁵, R⁶, and R⁷, independently of one another, are preferably saturated, but may also have one or more double bonds or triple bonds, which may be present in conjugation or in isolation in the chain.

Examples of radicals R⁴, R⁵, R⁶, and R⁷ as aliphatic groups are, independently of one another, hydrocarbon groups having 1 to 14 carbon atoms, such as methyl, ethyl, n-propyl, isopropyl, n-butyl, sec-butyl, tert-butyl, n-pentyl, n-hexyl, n-octyl, or n-decyl radicals for instance.

Examples of cycloaliphatic groups R⁴, R⁵, R⁶, and R⁷ are, independently of one another, cyclic hydrocarbon radicals which have between 3 and 20 carbon atoms, and may contain ring heteroatoms, such as oxygen, nitrogen, or sulfur atoms, for instance. The cycloaliphatic groups may further be saturated or have one or more double or triple bonds, which may be present in conjugation or in isolation in the ring. Saturated cycloaliphatic groups, more particularly saturated aliphatic hydrocarbons which have five to eight ring carbon atoms, preferably five and six ring carbon atoms, are preferred.

Aromatic groups, carbocyclic aromatic groups, or heterocyclic aromatic groups R⁴, R⁵, R⁶, and R⁷, independently of one another, preferably have between 6 and 22 carbon atoms, examples being phenyl, biphenylyl, naphthyl, binaphthylyl, or anthracyl radicals.

Independently of one another, oligoether groups R⁶ to R⁷ are preferably groups of the general formula (13)

—[(CH₂)ₓ—O]_{y}—R″ (13)

where
x is a number from 1 to 250,
y is a number from 2 to 250, and
R″ is an aliphatic, cycloaliphatic, aromatic or silyl group.

Organyloxy groups R⁶ and R⁷ are, independently of one another, preferably groups of the general formula

—[O—R′″] (14),

where R′″ is an aliphatic, cycloaliphatic, or aromatic group. Silyl and/or siloxy groups R⁶ and R⁷ are, independently of one another, preferably groups of the general formula

—[(O)ᵤ—Si—R″″₃] (15),

where u is 0 or 1 and
R″″ may be identical or different and are aliphatic, cycloaliphatic, or aromatic radicals or amine or alkoxy groups.

In each of the formulae (8) to (11), independently of one another, preferably at least one Y is a nitrogen atom, phosphorus atom, or oxygen atom, and more preferably both Y in each formula are nitrogen atoms.

Where Y or Z is carbon atom, the radicals R⁶ and R⁷ independently of one another are preferably hydrogen or organic radicals, more preferably hydrogen or aliphatic branched and unbranched hydrocarbon radicals. Where Y or Z is a heteroatom, the radicals R⁶ and R⁷ are preferably hydrogen or organic radicals, more preferably hydrogen or aliphatic branched and unbranched hydrocarbon radicals such as, for example, saturated linear and branched hydrocarbon radicals having 1 to 10 carbon atoms.

With particular, preference the cations [A]⁺ are cations of the formulae (9), (10), or (11).

More particularly the cations [A]⁺ of the formulae (9) to (11) are five- or six-membered rings.

More preferably, cation [A]⁺ comprises imidazolium, imidazolinium, imidazolidinium, pyridinium, pyrazolium, or pyrrolidinium cations, more preferably those in which the ring atoms in the case of Y and/or Z being C are bonded to hydrogen, to saturated linear and branched C1 to C10 hydrocarbon radicals, to alkoxy and/or to silyl groups, more particularly to hydrogen, and in which the ring atoms in the case of Y and/or Z being heteroatoms are bonded to hydrogen, to saturated linear and branched C1 to C10 hydrocarbon radicals, to alkoxy and/or to silyl groups, more particularly to linear and branched C1 to C10 hydrocarbon radicals, and, in the case of Y being nitrogen, additionally to hydrogen.

Component (D) preferably comprises imidazolium, imidazolinium, imidazolidinium, pyridinium, pyrazolium, or pyrrolidinium cations, and halides as anions, more particularly fluoride, chloride, bromide, or iodide.

Single compounds may be employed in the process of the invention, and also mixtures of these heteroatomic organic salts (D).

Component (D) employed in accordance with the invention may be solid or liquid at 20° C. and 1000 hPa.

In the process of the invention, component (D) may be used in pure form or in a mixture with component (A) or (B) or with a solvent (E).

In the process of the invention, component (D) is preferably used in amounts of 0.1 to 5 mol %, more preferably 0.1 to 2 mol %, based in each case on the limiting component (A) or (B) used.

In the process of the invention, components (C) and (D) are used in amounts such that the molar ratio of metal atom in component (C) to salt (D) is preferably 1:1 to 1:200, more preferably 1:1 to 1:25.

In addition to components (A), (B), (C), (D), and optionally (E), further components may be used in the process of the invention, although this is not preferred.

From the standpoint of the technical process, particularly in the case of a continuous operating regime, it may be of advantage to fill the plant with the desired target product even before the reaction of the invention is commenced, giving the target product the function of solvent as component (E). This is advantageous for managing the exothermic reaction, and has the advantage that, when the reaction mixture is worked up, no additional component detracts from the separation. In batchwise operation, the initial introduction of the target product likewise provides a possibility of managing the exothermic reaction when the reactants are metered; in order to optimize the space-time yield, however, not too much target product should be included in the initial charge. The fraction of target product included in the initial charge is preferably 5 to 50 wt %, more preferably 10 to 35 wt %, and most preferably 15 to 35 wt %, of the total mass at the start of the reaction.

In the process of the invention, preferably, no substances other than components (A) to (E) are additionally used.

The components used in the process of the invention may in each case comprise one kind of such a component or else a mixture of at least two kinds of a respective component.

In the process of the invention, the individual components may be mixed with one another in any desired manner known per se.

The process of the invention may be carried out either continuously or discontinuously; when using organosilicon compounds (A1), the continuous process is preferred, and when using polymeric organosilicon compounds (A2), the discontinuous process is preferred.

The process of the invention takes place in a single-phase or multiphase system. Where it is a multiphase reaction, two-phase or three-phase reactions are preferred. In one preferred embodiment of the process of the invention, catalyst (C) is used as liquid phase, the heteroatomic organic salt (D) is used as liquid or solid phase, and the reactants (A) and (B) are used as liquid phase or gas phase.

In the process of the invention, in the case of continuous operation, catalyst (C) is used in the form of a mixture with solvent (E) or with component (B1), in which, preferably, component (D) is suspended or dissolved, and this mixture is mixed with components (A) and (B), preferably using static mixers.

In another variant of the continuous process of the invention, the hydrosilylation reaction takes place in a fixed-bed reactor, with the heteroatomic organic salt (D) being applied to a support material, preferably silica, aluminum oxide and/or glass, and the transition metal catalyst (C) is brought to reaction together with Si—H compounds (A1) and with component (B1) in a gas-phase or liquid-phase reaction.

In the process of the invention, in the case of batchwise operation, component (D) is preferably included in the initial charge as a mixture with solvent (E).

According to a preferred batchwise process variant, solvent (E), chloropropylmethyldichlorosilane for example, is charged to a reaction vessel, after which component (D) is added and the contents of the reaction vessel are thoroughly mixed. The resulting reaction mixture is then preferably heated, and in parallel metal catalyst (C), preferably as mixtures with solvent (E) or component (B1), and a mixture of components (A), methyldichlorosilane for example, and (B), allyl chloride for example is metered, preferably until the boiling point of the mixture is reached and reflux begins. The boiling temperature is determined by the nature of the reaction components (reactants). The hydrosilylation reaction which begins is generally manifested by an increase in the temperature in the reaction vessel, because this addition reaction is exothermic. The conversion of the reactants is monitored generally by regular sampling and analysis of the ingredients by GC. When there is no significant increase found in the amount of the desired reaction product in the reaction mixture, the removal of the low-boiling constituents of the reaction mixture, preferably by distillation, can be commenced, optionally under reduced pressure. This may be followed by fine distillation of the product, an operation frequently also conducted under reduced pressure.

According to one preferred continuous process variant, component (A), component (B), a mixture of the metal catalyst (C), preferably in the form of a mixture with solvent (E) or component (B1), and component (D) are fed to the reactor concurrently at elevated temperature, preferably 30 to 110° C., preferably under slightly elevated pressure, more preferably 1000 to 10,000 hPa. When reaction is complete, the product can be subjected to fine distillation, for which it is possible to operate under reduced pressure.

The process of the invention preferably is carried out at a temperature in the range from 10 to 200° C., more preferably in the range from 20 to 150° C., most preferably 30 to 110° C. Furthermore, the process of the invention is carried out at a pressure in the range from preferably 1000 to 200,000 hPa (abs.), more preferably at 1000 to 20,000 hPa (abs.), and most preferably at 1000 to 10,000 hPa (abs.).

The process of the invention is preferably carried out under an inert gas atmosphere, such as under nitrogen or argon, for example.

The process of the invention is carried out preferably in the absence of moisture.

After the end of the reaction, the products are obtained directly, preferably with a purity of >60 wt %. The purity of the distilled product is preferably >98 wt %.

The products produced in accordance with the invention can be used for all purposes for which organosilanes are useful. They may also be subjected to any desired form of further processing. For instance, where the products are chlorosilanes, the Si-bonded chlorine atoms can be esterified with an alcohol in a conventional way, to give alkoxysilanes. The alcohols used for the esterification of the invention are preferably methanol, ethanol, or 2-methoxyethanol.

The process of the invention has the advantage that it is simple to implement and allows the preparation, in an economic way, of hydrosilylation products such as 3-chloropropylmethyldichlorosilane, for example, with outstanding yield.

The process of the invention has the advantage, furthermore, that it has high selectivity and allows effective utilization of valuable Si—H components.

Furthermore, the process of the invention has the advantage that only small amounts of component (D) need be used, with economic advantages on the one hand and, on the other, no disruptive influence on the isolation of product.

Particularly surprising and of utmost economic significance, finally, is the fact that for the particularly preferred variants of the process of the invention, an increased selectivity to the desired product of the hydrosilylation reaction, with accompanying increased conversion, is observed.

The process of the invention shows an unexpected technical solution which is based on the finding that the transition metal complexes catalyze hydrosilylation with addition of very small amounts of one or more organic salts which contain one or more heteroatoms, but surprisingly catalyze a hydrosilylation of Si—H compounds in a multiphase reaction regime, in a selective way, with a high yield.

This was possible in the process of the invention through the addition of co-catalytic amounts of one or more organic salts containing one or more heteroatoms. The essential advantage relative to the known synthesis process lies in a significant improvement in selectivity and in yield during silane synthesis. Furthermore, in accordance with this invention, only very small, cocatalytic amounts of this organic salt are needed for a significant improvement in reaction outcomes.

Another advantage of the present invention is that these organic salts can be used in the form of solids and hence after the end of reaction are easy to remove from the product mixture and recycle.

The fact that this reaction is accomplished with the high selectivities achieved is accomplished was very surprising, since organic salts were employed only in the form of a solvent up to the present-day state of the art.

In the examples described below, all parts and percentages are given by weight unless indicated otherwise. Unless indicated otherwise, the examples which follow are carried out under the pressure of the surrounding atmosphere, in other words approximately at 1000 hPa, and at room temperature, in other words at approximately 20° C., or at a temperature which comes about when the reactants are combined at room temperature without additional heating or cooling.

The selectivities reported in table 1 relate to the reactions set out as follows:

HSiCl₂(CH₃)+H₂C═CH—CH₂—Cl→[SiCl₂(CH₃)]—CH₂—CH₂—CH₂—Cl (I)

HSiCl₂(CH₃)+H₂C═CH—CH₂—Cl→H₂C═CH—CH₃+SiCl₃(CH₃) (II)

HSiCl₂(CH₃)+H₂C═CH—CH₃→[SiCl₂(CH₃)]—CH₂—CH₂—CH₃ (III)

The selectivities reported in table 2 pertain to the reactions set out as follows:

HSiCl₃+H₂C═CH—CH₂—Cl→[SiCl₃]—CH₂—CH₂—CH₂—Cl (I)

HSiCl₃+H₂C═CH—CH₂—Cl→H₂C═CH—CH₃+SiCl₄ (II)

HSiCl₃+H₂C═CH—CH₃→[SiCl₃]—CH₂—CH₂—CH₃ (III)

S1: selectivity in relation to secondary reaction (II)

S1=mol product/(mol product+mol byproduct)*100%

S2: selectivity in relation to follow-on reaction (III)

S2=mol follow-on product/(mol product+mol follow-on product)*100%

### Comparative Example 1

A 50 ml flask equipped with reflux condenser, magnetic stirrer, thermometer, and two dropping funnels is charged under a nitrogen atmosphere with 18.9 g of dichloro(3-chloropropyl)methylsilane and this initial charge is heated to 90° C. At that temperature, over the course of 1 h 45 min, a mixture of 10.5 g (0.14 mol) of allyl chloride and 33.8 g (0.29 mol) of dichloromethylsilane is metered in. Added in parallel over the same period of time are 5.066 g of catalyst mixture, consisting of 0.066 g of platinum(IV) chloride solution in 1-dodecene, with a Pt content of 4 wt %, and 5.0 g (0.06 mol) of allyl chloride. The temperature is held at 90° C. for one hour more. After the end of this reaction time, 3 drops of 1% strength toluenic triphenylphosphine solution are added to the mixture, and a sample is taken and analyzed by gas chromatography. Results can be taken from table 1.

### Example 1

The procedure described in comparative example 1 is repeated, with the modification that in addition to dichloro(3-chloropropyl)methylsilane, the 50 ml flask is charged with 0.34 g (1.52 mmol or 0.5 wt %, based on the total amount of the components used) of 1,3-dimethylimidazolium iodide. Results can be taken from table 1.

### Example 2

The procedure described in example 1 is repeated, with the modification that in addition to dichloro(3-chloropropyl)methylsilane, the 50 ml flask is charged with 0.14 g (0.62 mmol or 0.2 wt %, based on the total amount of the component used) of 1,3-dimethylimidazolium iodide. Results can be taken from table 1.

### Example 3

The procedure described in example 1 is repeated, with the modification that in addition to dichloro(3-chloropropyl)methylsilane, the 50 ml flask is charged with 0.34 g (1.95 mmol or 0.5 wt %, based on the total amount of the component used) of 1-butyl-3-methylimidazolium chloride. Results can be taken from table 1.

### Example 4

The procedure described in example 1 is repeated, with the modification that in addition to dichloro(3-chloropropyl)methylsilane, the 50 ml flask is charged with 0.34 g (1.72 mmol or 0.5 wt %, based on the total amount of the component used) of 1-butyl-3-methylimidazolium thiocyanate. Results can be taken from table 1.

### Example 5

The procedure described in example 1 is repeated, with the modification that in addition to dichloro(3-chloropropyl)methylsilane, the 50 ml flask is charged with 0.34 g (1.50 mmol or 0.5 wt %, based on the total amount of the component used) of 1-butyl-3-methylimidazolium tetrafluoroborate. Results can be taken from table 1.

### Example 6

The procedure described in example 1 is repeated, with the modification that in addition to dichloro(3-chloropropyl)methylsilane, the 50 ml flask is charged with 0.34 g (1.24 mmol or 0.5 wt %, based on the total amount of the component used) of 1,3-dimethoxyimidazolium hexafluorophosphate. Results can be taken from table 1.

### Example 7

The procedure described in example 1 is repeated, with the modification that in addition to dichloro(3-chloropropyl)methylsilane, the 50 ml flask is charged with 0.17 g (1.63 mmol or 0.25 wt %, based on the total amount of the component used) of imidazole hydrochloride. Results can be taken from table 1.

### Example 8

A 50 ml flask is charged with 18.9 g of dichloro(3-chloropropyl)methylsilane. 0.17 g (0.76 mmol or 0.25 wt %, based on the total amount of the components used) of 1,3-dimethylimidazolium iodide is added. At a temperature of between 90 and 100° C., over the course of 1 h 45 min, a mixture of 10.5 g (0.14 mol) of allyl chloride and 33.8 g (0.29 mol) of dichloromethylsilane is metered in. Over the same period of time, 5.033 g of catalyst solution, consisting of 0.033 g of platinum(IV) chloride solution in 1-dodecene, with a Pt content of 4 wt %, and 5.0 g (0.06 mol) of allyl chloride are added. The temperature is maintained for a further hour. After the end of this reaction time, 3 drops of 1% strength toluenic triphenylphosphine solution are added to the mixture, and a sample is taken and analyzed by gas chromatography. Results can be taken from table 1.

### Example 9

A 50 ml flask is charged with 18.9 g of dichloro(3-chloropropyl)methylsilane. 0.17 g (0.76 mmol or 0.25 wt %, based on the total amount of the components used) of imidazole hydrochloride is added. Further procedure is as described in example 8. Results can be taken from table 1.

### Comparative Example 2

A 50 ml flask equipped with reflux condenser, magnetic stirrer, thermometer, and two dropping funnels is charged under a nitrogen atmosphere with 18.9 g of trichloro(3-chloropropyl) silane and this initial charge is heated to 90° C. At that temperature, over the course of 1 h 45 min, a mixture of 10.5 g (0.14 mol) of allyl chloride and 33.8 g (0.25 mol) of trichlorosilane is metered in. Added in parallel over the same period of time are 5.066 g of catalyst mixture, consisting of 0.066 g of platinum(IV) chloride solution in 1-dodecene, with a Pt content of 4 wt %, and 5.0 g (0.06 mol) of allyl chloride. The temperature is held at 90° C. for one hour more. After the end of this reaction time, 3 drops of 1% strength toluenic triphenylphosphine solution are added to the mixture, and a sample is taken and analyzed by gas chromatography. Results can be taken from table 2.

### Example 10

The procedure described in comparative example 2 is repeated, with the modification that the 50 ml flask, as well as trichloro(3-chloropropyl)silane, is charged with 0.34 g (0.003 mol or 0.5 wt %, based on the total amount of the components used) of imidazole hydrochloride. Results can be taken from table 2.

TABLE 1

| | Yield of | | | Conversion of |
|---|---|---|---|---|
| | product* | S1 | S2 | allyl chloride |
| Examples | [wt %] | [wt %] | [wt %] | [wt %] |
| C1 | 50.0 | 56.0 | 54.6 | 100 |
| E1 | 62.2 | 72.9 | 96.6 | 96.8 |
| E2 | 63.0 | 70.1 | 89.3 | 100 |
| E3 | 57.0 | 68.5 | 98.2 | 87.8 |
| E4 | 57.2 | 71.1 | 98.5 | 83.2 |
| E5 | 64.7 | 70.3 | 82.3 | 100 |
| E6 | 59.2 | 70.5 | 95.7 | 88.3 |
| E7 | 68.9 | 74.1 | 81.6 | 100 |
| E8 | 66.7 | 72.4 | 94.5 | 99.8 |
| E9 | 68.5 | 73.6 | 84.6 | 99.9 |

*product = dichloro(3-chloropropyl)(methyl)silane

TABLE 2

| | Yield of | | | Conversion of |
|---|---|---|---|---|
| | product** | S1 | S2 | allyl chloride |
| Examples | [wt %] | [wt %] | [wt %] | [wt %] |
| C2 | 43.3 | 46.4 | 70.1 | 99.9 |
| E10 | 66.8 | 77.0 | 97.6 | 91.6 |

**product = trichloro(3-chloropropyl)silane

1.-10. (canceled)

11. A process for the addition of Si-bonded hydrogen onto an aliphatic carbon-carbon multiple bond, comprising:
reacting
(A) organosilicon compounds having Si-bonded hydrogen atoms with
(B) compounds which have aliphatic carbon-carbon multiple bonds,
in the presence of
(C) a metal catalyst which promotes the addition of Si-bonded hydrogen onto an aliphatic multiple bond in an amount of 1 to 500 mol-ppm, based on a limiting component (A) or (B), and
(D) at least one organic salt of the formula
[A]⁺[Y]⁻ (5),
where
[Y]⁻ is an inorganic or organic anion and
[A]⁺ is an organic cation which contains at least one heteroatom selected from the group consisting of nitrogen, phosphorus, oxygen, and sulfur, in an amount of 0.01 to 10 mol %, based on the deficit component (A) or (B),
with the proviso that the molar ratio of metal atom in component (C) to salt (D) is 1:1 to 1:500.

12. The process of claim 11, wherein component (A) comprises at least one hydrogensilane (A1) of the formula
H_{4-a-b}SiRₐX_{b} (1)
where
R are identical or different optionally substituted hydrocarbon radicals free from aliphatic carbon-carbon multiple bonds,
X are identical or different and are chlorine, bromine, methoxy, or ethoxy,
a is 0, 1, 2 or 3, and
b is 0, 1, 2 or 3, with the proviso that the sum a+b is 1, 2 or 3.

13. The process of claim 11, wherein component (B) comprises silicon-free organic compounds (B1).

14. The process of claim 12, wherein component (B) comprises silicon-free organic compounds (B1).

15. The process of claim 11, wherein the molar ratio of aliphatically unsaturated groups in constituent (B) to SiH groups in constituent (A) is 20:1 to 1:20.

16. The process of claim 11, wherein component (C) comprises one or more complex compounds of platinum, of iridium, or rhodium.

17. The process of claim 11, wherein the anion [Y]⁻ comprises an inorganic anion.

18. The process of claim 11, wherein cation [A]⁺ comprises cations selected from the group consisting of
a) ammonium cations of the formula
[NR⁴₄]⁺ (6),
b) phosphonium cations of the formula
[PR⁵₄]⁺ (7),
c) heteroorganic cations of the formula (8), 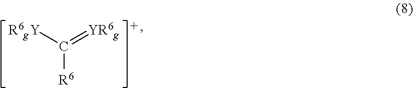
heterocyclic organic cations of the formulae (9), (10) and (11), where in the case of formula (11) the compound may be an aromatic compound in the sense of the Hückel rule with (4n+2) Π electrons, 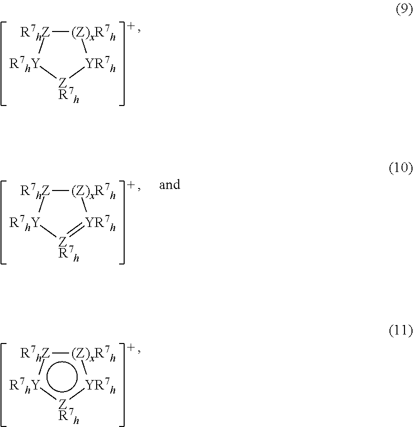
where
k independently at each occurrence is 0, 1 or 2,
Y independently at each occurrence is identical or different and is N, O, S, C, or P,
Z independently at each occurrence is identical or different and is C, N, O, S, P, or Si,
R⁴, R⁵, R⁶, and R⁷ in each case independently of one another are identical or different and are hydrogen or an organic radical,
g independently at each occurrence is identical or different and is 0, 1, 2, 3, or 4, depending on the valence of Y, and
h independently at each occurrence is identical or different and is 0, 1, 2, or 3, depending on the valence of Z or Y, respectively,
with the proviso that in the formulae (8), (9), (10), and (11), the number of the radicals R⁶ and R⁷ on one of the atoms Y defined as a heteroatom, or Z defined as a heteroatom, is selected in each case such that a singly positive charge is carried by a heteroatom, and also only at most one of the two Y atoms in each formula may is a carbon atom.

19. The process of claim 11, wherein cation [A]⁺ comprises an imidazolium, imidazolinium, imidazolidinium, pyridinium, pyrazolium, or pyrrolidinium cation.

20. The process of claim 11, wherein component (D) comprises an imidazolium, imidazolinium, imidazolidinium, pyridinium, pyrazolium, or pyrrolidinium cation, and halides as anions.

21. The process of claim 11, wherein components (C) and (D) are used in amounts such that the molar ratio of metal atom in component (C) to salt (D) is 1:1 to 1:200
